(19) United States
(12) Patent Application Publication
(10) Pub. No.: US 2003/0111292 A1
(43) Pub. Date: Jun. 19, 2003

(54) Ground runup enclosure and method for testing aircraft engines

(76) Inventor: Markus Hess, Toronto (CA)

Correspondence Address: KIRKPATRICK & LOCKHART LLP, 535 SMITHFIELD STREET, PITTSBURGH, PA, 15222, US

(21) Appl. No.: 10/032,226

(22) Filed: Dec. 18, 2001

(51) Int. Cl. B64F 1/26; G10K 11/00; E04H 17/00

(52) U.S. Cl. 181/210; 181/205; 181/203

(57) ABSTRACT

A method is disclosed for testing a jet aircraft engine at a time when an actual wind direction differs from a prevailing wind direction. The method is conducted in a ground runup enclosure (GRE), typically comprising a rear wall, a pair of side walls attached to the rear walls and an open front side opposite the rear wall, the front side facing in a prevailing wind direction. The method comprises moving the aircraft into the GRE, aligning the aircraft so that the air inlet of its engine faces the actual wind direction, and running the engine up to full power to test its condition. The method of the present invention permits the GRE to be used under a variety of unfavourable wind conditions, thereby improving its usability.

### FIELD OF THE INVENTION

The present invention relates to the use of ground runup enclosures for testing aircraft engines.

### BACKGROUND OF THE INVENTION

Ground runup enclosures (GRE's) are used at airports to run jet engines up to full power in order to test their condition. A typical GRE comprises a rear wall, two side walls and an open front. A jet aircraft is backed into the GRE so that the nose of the aircraft is facing the open front of the GRE and the fuselage of the aircraft is generally parallel to the side walls. In this orientation, the air inlets of the jet engine are facing the open front of the GRE, and the exhaust outlets are facing the rear wall.

The purpose of a GRE is twofold. Firstly, the GRE protects the airport and surrounding area from the force of the blast from the jet engines and the great amount of noise generated by the engines at full runup. In a typical GRE, the jet blast is directed upward into the atmosphere by a blast fence, obliquely inclined relative to the ground and being positioned between the tail of the aircraft and the rear wall of the GRE. Examples of this arrangement are shown in U.S. Pat. No. 4,958,700 (Schafhaupt), U. S. Pat. No. 5,856,640 (Lynn) and U.S. Pat. No. 6,016,888 (Lynn). The blast fence may be constructed of a mesh-like material to allow the sound waves emitted by the engines to pass through and be partially absorbed by the rear wall. The side walls and front walls, if present, also absorb some of the engine noise.

Secondly, the GRE is designed to minimize the effect of irregular winds on the jet engines during testing. As explained in the discussion of background art in U.S. Pat. No. 5,591,904 (Schafhaupt et al), aircraft are preferably aligned so that the air inlets of the jet engines are facing into the wind during testing. This is done to minimize the creation of high disturbances in the intake stream of the engine which can cause engine malfunction and shorten engine life. Thus, the GRE is aligned so that the open front of the enclosure is facing into the direction of the prevailing winds. During unfavourable wind conditions, the side walls shield the engines somewhat, thereby permitting testing to be conducted under a variety of wind conditions.

However, there are limits to the conditions under which GRE's are effective. For example, the walls of the GRE cannot shield jet engines from winds which deviate from the prevailing direction significantly, particularly those having high velocity. Thus, depending on the size of the aircraft being tested, the usability of a GRE may not exceed about 80 percent, meaning that there will be a significant amount of time during which testing cannot be conducted inside the GRE.

Although a number of GRE's have been developed, none have addressed this problem in a satisfactory manner.

U.S. Pat. No. 3,096,847 (Hardy) discloses an early example of an acoustic barrier which substantially completely surrounds an aircraft during engine runup. The enclosure disclosed by Hardy is six-sided and conforms closely to the configuration of the airplane. The walls are inclined at 45 to 80 degrees to the horizontal and have a height of about 20 feet. A pair of hinged gate members are provided at the front of the enclosure to substantially completely surround the aircraft during testing. Hardy does not discuss alignment of the enclosure relative to the prevailing winds, and it is unlikely that alignment of the enclosure was considered since two of the enclosures shown in FIG. 1 of Hardy are aligned in opposite directions.

U.S. Pat. No. 3,842,941 (Gerber) describes a sound dampening runup installation for aircraft which permits alignment of the aircraft to compensate for changes in wind direction. Gerber provides a disc-shaped installation having a roof disc and a floor disc, both of which are filled with sound-absorbing material. During testing, an aircraft is anchored to a turntable which is countersunk into the floor disc. The turntable is then rotated to turn the aircraft into the wind. The walls of the installation comprise sound-dampening screens which are rotatably disposed so that they can be aligned in the direction of the wind.

U.S. Pat. No. 4,958,700 (Schafhaupt) describes a protective facility for suppressing jet aircraft noise which is generally horseshoe-shaped with two hinged front walls capable of pivoting and being of such length that when completely swung inward, they leave a gap for the nose of an aircraft. According to Schafhaupt, interfering wind loads are largely excluded by the described structure since the aircraft and the engines are enclosed and shielded on practically all sides. As mentioned above, Schafhaupt provides a latticed blast fence positioned directly behind the aircraft to deflect gas flows from the engines upward while allowing sound waves to pass through to be absorbed by noise-suppressive elements on the rear wall of the facility.

U.S. Pat. No. 6,016,888 (Lynn) describes a package of aerodynamic enhancements designed to improve the usability of GRE's. The GRE disclosed by this patent comprises a three-sided enclosure oriented with the open end facing the prevailing wind direction, has a jet blast deflector positioned ahead of the rear wall. The aerodynamic enhancements comprise a rolled top on the GRE walls, vented side walls and a sloped entry lip at the front ends of the side walls.

Despite the above improvements, it is desired to further improve the usability of GRE's while avoiding the costly solution proposed by Gerber and without constructing multiple enclosures as proposed by Hardy.

### SUMMARY OF THE INVENTION

The present invention overcomes at least some of the above-described problems of the prior art by providing a method for testing jet aircraft engines in a GRE at times when the actual wind direction differs from the prevailing wind direction. Simply stated, the method of the invention comprises turning the aircraft inside the GRE so that the aircraft axis, and the air inlets of the jet engines, face the actual wind direction rather than the prevailing wind direction. By aligning the aircraft to face into the wind direction, the usability rate of the GRE can be increased significantly, particularly for relatively small jet aircraft for which standard GRE usability rates typically do not exceed about 80 percent.

In order to practice the method of the present invention, it is desired to modify the GRE somewhat. Since the jet engine blast may not be directed entirely at the rear wall of the GRE, it is desirable to construct both the rear wall and the side walls so that their inner faces form an oblique angle with the ground, and are therefore able to direct the force of the jet blast upward into the atmosphere. Also, the side walls and the rear wall should be constructed so that they are able to withstand the force of the jet blast.

Further, the blast of the jet engines may be directed at the corners where the rear wall meets the side walls of the GRE. In order to ensure that the corners are of sufficient strength to withstand a jet blast, and to ensure that a jet blast aimed at the corners will be directed upwardly, it is desirable to construct the GRE so that the side walls and the rear wall meet at angles greater than 90 degrees. For example, it may be preferred to construct the GRE so that the side walls and the rear wall are arcuate, or so that the side walls and the rear wall form a portion of a polygon having greater than four sides.

In order to permit a jet aircraft to turn into alignment with the actual wind direction, the GRE according to the invention is preferably of sufficient width and depth to permit the aircraft to turn while inside the GRE. In one aspect, the present invention provides a method for testing an engine of a jet aircraft in a ground runup enclosure at a time when an actual wind direction differs from a prevailing wind direction, said jet aircraft having an elongate body defining an aircraft axis and said engine having an air inlet and an exhaust outlet aligned substantially parallel to said aircraft axis, said ground runup enclosure having a rear wall, a pair of side walls attached to the rear wall and an open front side opposite said rear wall, said front side facing in said prevailing wind direction, said method comprising: (a) moving said jet aircraft into said ground runup enclosure; (b) aligning said jet aircraft with the aircraft axis substantially parallel to the actual wind direction and with the air inlet of said engine facing said actual wind direction; and (c) running said engine up to full power to test its condition.

In another aspect, the present invention provides a ground runup enclosure, comprising: (a) a rear wall; (b) a pair of side walls, each of which is connected to said rear wall at an oblique angle; and (c) an open front, said rear walls, side walls and open front together forming a generally U-shaped enclosure having sufficient width and depth to enclose a jet aircraft and with the open front being of sufficient width to permit said jet aircraft to enter said U-shaped enclosure; wherein said side walls and said rear wall each have an inner face sloped downwardly and inwardly so as to form an oblique angle with the ground and are constructed so as to withstand a blast from a jet engine.

### BRIEF DESCRIPTION OF THE DRAWINGS

The invention will now be described, by way of example only, with reference to the accompanying drawings in which:

FIG. 1 is a plan view of a ground runup enclosure according to the invention;

FIG. 2 is a side view, partly in cross-section, along line 2-2′ of FIG. 1; and

FIG. 3 is a front view, partly in cross section, along line 3-3′ of FIG. 1.

### DETAILED DESCRIPTION OF PREFERRED EMBODIMENTS

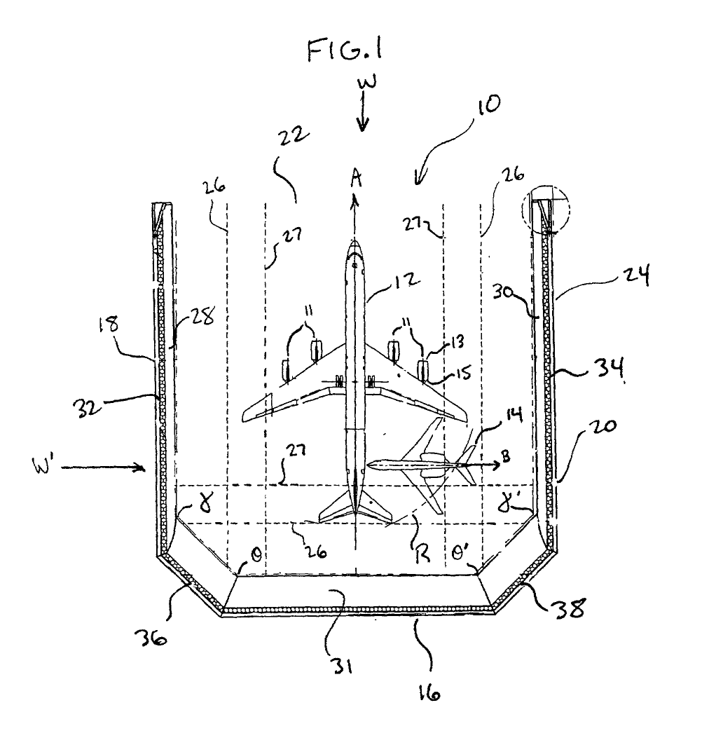

FIGS. 1 to 3 illustrate a preferred GRE 10 according to the invention. The GRE 10 comprises a rear wall 16, a pair of side walls 18, 20 connected to the rear wall 16 at oblique angles θ and θ′, and an open front 22.

The outlines of two jet aircraft are shown in the GRE, one of which is a relatively large four engine aircraft 12 such as a Boeing 727 and the other of which is a smaller twin engine aircraft 14 such as a Citation. The aircraft 12, 14 each have an elongate body or fuselage defining an aircraft axis, labeled A for aircraft 12 and B for aircraft 14. Each engine 11 of aircraft 12 has an air inlet 13 and an exhaust outlet 15 aligned substantially parallel to the aircraft axis A. The air inlets and exhaust outlets of the engines of aircraft 14 are similarly aligned with aircraft axis B.

The walls 16, 18, 20 and the open front 22 together form a generally U-shaped enclosure 24. The enclosure 24 has sufficient width (measured as the distance between side walls 18, 20) and sufficient depth (measured as the distance from the front 22 of the enclosure 24 to the rear wall 16) to enclose the aircraft 12, 14. The open front 22 is preferably of sufficient width (measured as the distance between the front ends of the side walls 18, 20) to permit the aircraft 12 or 14 to enter the U-shaped enclosure 24. Preferably, the enclosure 24 is of sufficient size to accommodate very large aircraft such as the Boeing 777.

The jet aircraft 12, 14 will typically enter the enclosure 24 under its own power or be towed in, with the aircraft axis generally parallel to the prevailing wind direction, labeled W in FIG. 1. Once inside the enclosure, it is determined whether or not the aircraft must be turned to face the actual wind direction. Preferably, the length and depth of enclosure 24 is sufficient to permit the aircraft to be turned after it has entered the enclosure 24. FIG. 1 illustrates the turn radius R of aircraft 12, and also designates by lines 26 the area beyond which the tail of the aircraft should not protrude. This is both to prevent the aircraft from coming too close to the walls of enclosure 24, both to avoid contact between the tail and the walls 16, 18 and 20, and to prevent damage to the surfaces near the edges of the enclosure 24, which may preferably be thinner than the surfaces at the centre of the enclosure, and insufficient to support the weight of the aircraft.

In addition, the lines identified by reference numeral 27 in FIG. 1 enclose an area inside which the engines of aircraft 12, 14 should be positioned during testing.

In the preferred embodiment shown in the drawings, the depth of the enclosure 24, measured from the front end of side walls 18, 20 to the inner face of rear wall 16, is about 250 feet. The width of the enclosure 24 and the width of the open front 22 are the same, being about 240 feet. These dimensions are sufficient to permit very large aircraft, such as the Boeing 777, to use the GRE 10.

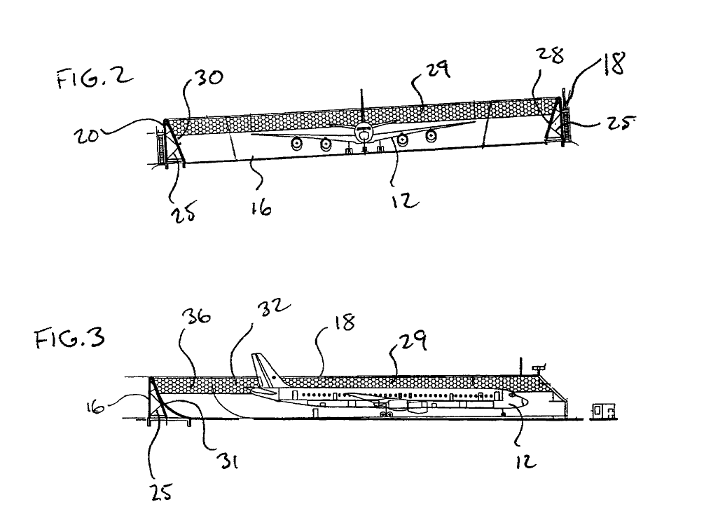

The preferred shape of the side walls 18, 20 are shown in FIG. 2 and the preferred shape of the rear wall is shown in FIG. 3 As shown, the side walls 18, 20 and the rear wall 16 each have an inner face sloped downwardly and inwardly so as to form an oblique angle with the ground and are constructed so as to withstand a blast from a jet engine. Preferably, the inner faces 28, 30 of side walls 18, 20 form an angle of greater than about 100 degrees with the ground, more preferably from about 100 to about 135 degrees, and even more preferably from about 105 to about 135 degrees. In the preferred embodiment shown in the drawings, the inner faces 28, 30 of side walls 18, 20 form an angle of about 110 degrees with the ground. The height of the side walls 18, 20 is preferably from about 20 to about 40 feet, more preferably about 30 feet.

The side walls and rear wall of the enclosure 24 are preferably of an A-frame construction, and are constructed of structural steel frame members 25 (FIGS. 2 and 3) covered by sheet metal to form the inner faces and outer faces of the side walls and rear wall. Preferably, the inner surfaces of the rear wall and side walls are formed from 12 to 16 gauge corrugated steel sheets, and the upper portions of the side walls and rear wall may preferably be provided with acoustic panels 29. Preferably, panels 29 cover only an upper portion of the side walls and rear wall, more preferably about the top ten feet. The outer surfaces of the side walls and rear wall are preferably formed from sheet metal which may preferably be of thinner gauge, typically 22 to 24 gauge, than the inner surfaces.

The rear wall 16 of enclosure 24 may preferably be of the same height and inclination as the side walls 18, 20. In the embodiment shown in the drawings, the rear wall 16 is of the same height as side walls 18, 20 and has an inner face 31, the upper portion of which is inclined at about 110 degrees. However, the lower portion of rear wall 16 is arcuate and is similar in shape to a blast fence, in order to direct the force of the jet blast upwards into the atmosphere.

In order to avoid the formation of right angles at the corners where the rear wall 16 meets side walls 18, 20, the sidewalls are comprised of forward portions 32, 34 and rearward portions 36, 38. The forward portions 32, 34 of side walls 18, 20 are perpendicular to the rear wall 16 and are parallel to the prevailing wind direction. The rearward portions 36, 38 are connected to the forward portions 32, 34 of side walls 18, 20 at oblique angles γ and γ′ and, as mentioned above, are connected to rear wall 16 at oblique angles θ and θ′, thereby forming a more gradual transition between the side walls and the rear wall. In the preferred embodiment shown in the drawings, angles θ, θ′, γ and γ′ are all about 45 degrees.

In the preferred embodiment shown in the drawings, the rear portions 36, 38 of side walls 18, 20 have arcuate inner faces similar or identical to that of the rear wall 16 so as to upwardly direct jet engine blasts which are directed toward the corners.

It will be appreciated that many other configurations are possible for enclosure 24 which avoid the formation of right angles between the rear wall and the side walls. For example, the enclosure 24 may comprise a portion of any regular or irregular polygon having more than four sides, for example a pentagon, hexagon, heptagon, octagon, etc. Furthermore, one or more of the rear wall and the side walls, or portions thereof, can have an arcuate shape (in plan view), to form rounded transitions between the side walls and the rear wall.

It will be appreciated that the GRE 10 may further comprise front walls (not shown) which can be opened to permit an aircraft to enter the GRE 10 and can then be partially or completely closed, as shown in the above-mentioned Hardy patent and Schafhaupt '700 patents. The front walls may preferably have the same construction as the side walls, being inclined at an oblique angle relative to the ground, thereby permitting the aircraft to be tested even when the wind direction is directed close to or at 180 degrees to the prevailing wind direction.

As mentioned above, once the aircraft enters the enclosure 24, a determination is made as to whether the aircraft is to be tested with its axis parallel to the prevailing wind direction, as with aircraft 12 in FIG. 1, or whether it is to be turned to face the actual wind direction.

Where the aircraft is to be turned, it is preferably turned with its tail remaining inside the area designated by lines 26 until the aircraft axis is parallel to the actual wind direction. For example, FIG. 1 illustrates aircraft 14 having been turned by about 90 degrees in order to face the actual wind direction W′, with the air inlets facing into the wind.

Scale model testing has shown that the method of the present invention can have a significant positive impact on GRE usability, particularly for smaller aircraft for which conventional GRE testing is available only about 80 percent of the time.

Although the preferred embodiment of the invention relates to a GRE which faces into the prevailing wind direction, it will be appreciated that the present invention includes within its scope embodiments in which the open front of the GRE faces a direction other than the prevailing wind direction. For example, in certain areas the winds may be from the prevailing wind direction for less than 50 percent of the time, such that a GRE aligned with the prevailing winds would be subjected to crosswinds for a great proportion of the time. In such circumstances, it may be preferred to align the GRE so that it faces the average direction of the crosswinds, rather than the prevailing wind direction, to further improve the usability of the GRE.

Although the invention has been described in connection with certain preferred embodiments, it is not limited thereto. Rather, the invention includes within its scope all embodiments which may fall within the scope of the following claims.

What is claimed is:

1. A method for testing an engine of a jet aircraft in a ground runup enclosure at a time when an actual wind direction differs from a prevailing wind direction, said jet aircraft having an elongate body defining an aircraft axis and said engine having an air inlet and an exhaust outlet aligned substantially parallel to said aircraft axis, said ground runup enclosure having a rear wall, a pair of side walls attached to the rear wall and an open front side opposite said rear wall, said method comprising:
(a) moving said jet aircraft into said ground runup enclosure;
(b) aligning said jet aircraft with the aircraft axis substantially parallel to the actual wind direction and with the air inlet of said engine facing said actual wind direction; and
(c) running said engine up to full power to test its condition.

2. The method of claim 1, wherein step (a) comprises moving the jet aircraft into the ground runup enclosure with the aircraft axis substantially perpendicular to the rear wall.

3. The method of claim 2, wherein step (b) comprises turning the jet aircraft within the ground runup enclosure.

4. The method of claim 1, wherein the front side of the ground runup enclosure faces the prevailing wind direction.

5. A ground runup enclosure, comprising:
(a) a rear wall;
(b) a pair of side walls, each of which is connected to said rear wall at an oblique angle; and
(c) an open front, said rear walls, side wails and open front together forming a generally U-shaped enclosure having sufficient width and depth to enclose a jet aircraft and with the open front being of sufficient width to permit said jet aircraft to enter said U-shaped enclosure;
wherein said side walls and said rear wall each have an inner face sloped downwardly and inwardly so as to form an oblique angle with the ground and are constructed so as to withstand a blast from a jet engine.

6. The ground runup enclosure of claim 5, wherein at least a portion of said rear wall is substantially perpendicular to at least a portion of each of said side walls.

7. The ground runup enclosure of claim 5, wherein each of said side walls comprises a forward portion and a rearward portion through which the side wall is connected to the rear wall, the rearward portion of each said side wall being connected to the forward portion of the side wall and the rear wall at oblique angles.

8. The ground runup enclosure of claim 5, wherein the enclosure formed by the rear wall and the side walls comprises a portion of a polygon having greater than four sides.

9. The ground runup enclosure of claim 5, wherein one or more of the rear wall and the side walls is arcuate.

10. The ground runup enclosure of claim 5, wherein the inner face of each of the side walls and the rear wall forms an angle of from about 105 to about 135 degrees with the ground.

11. The ground runup enclosure of claim 5, wherein the width and depth of said enclosure are greater than a length of said jet aircraft.

12. The ground runup enclosure of claim 5, wherein the width and depth of said enclosure are greater than a wingspan of said jet aircraft.

13. The ground runup enclosure of claim 5, wherein the width and depth of said enclosure are sufficient to permit said jet aircraft to turn while inside said enclosure.

14. The ground runup enclosure of claim 5, wherein said side walls and said rear wall each have a height of from about 20 to about 40 feet.

15. The ground runup enclosure of claim 5, wherein the rear wall of the enclosure has an arcuate inner face so as to upwardly direct the blast from the jet engine.

16. The ground runup enclosure of claim 5, wherein each of said side walls comprises a forward portion and a rearward portion through which the side wall is connected to the rear wall, the rearward portion of each said side wall being connected to the forward portion of the side wall and the rear wall at oblique angles, and wherein the rear wall of the enclosure and the rearward portions of the side walls each have an arcuate inner face so as to upwardly direct the blast from the jet engine.

17. The ground runup enclosure of claim 5, wherein the open front of the enclosure faces a prevailing wind direction.

18. The ground runup enclosure of claim 5, wherein the open front of the enclosure faces a direction other than a prevailing wind direction.
